(19) United States
(12) Patent Application Publication
(10) Pub. No.: US 2006/0053198 A1
(43) Pub. Date: Mar. 9, 2006

(54) Configuring monitored information in an email response management system

(76) Inventors: Thorsten Pricken, San Mateo, CA (US); Yufeng Zhou, Sunnyvale, CA (US); Janaki P. Kumar, Palo Alto, CA (US); Jodette Kruger, Daly City, CA (US)

Correspondence Address: FISH & RICHARDSON, P.C., PO BOX 1022, MINNEAPOLIS, MN, 55440-1022, US

(21) Appl. No.: 10/933,654

(22) Filed: Sep. 3, 2004

(51) Int. Cl. G06F 15/16; G06F 15/173

(52) U.S. Cl. 709/206; 709/224

(57) ABSTRACT

One implementation provides a method for providing a graphical user interface (GUI) that allows a user to customize processing of incoming electronic mail (email) messages. This method is performed in a system that receives incoming email messages and manages events that may alter statuses of these messages. The method includes displaying in the GUI representations of predefined events that may occur during various stages of processing of incoming email messages, and receiving input from the user to map a predefined event to a predefined status indicator, such that the system assigns the predefined status indicator to an incoming email message when the predefined event that affects the incoming email message occurs.

### TECHNICAL FIELD

This application relates to computing systems that manage electronic mail messages.

### BACKGROUND

Often, customers or other end users who encounter difficulties when trying to solve problems send electronic mail (email) messages to an email response management system (ERMS). For example, if a customer has a problem installing or troubleshooting a home alarm system, the customer may send an email message to an ERMS for the home alarm service center. The customer may include within the email message a description of the type of alarm system being used and the details of the problem encountered. The customer may address the email message to a general address for the service center, such as “help@company.com”.

Over the course of a given day, the ERMS described above may receive hundreds of email messages from different customers requesting assistance. These email messages may all be addressed to the general address of “help@company.com”. The types of alarm systems and problems encountered described in these email messages, however, may vary greatly. As such, the ERMS typically process these incoming email messages in various stages. Firstly, the ERMS may analyze these incoming email messages to identify the users who have sent the messages and to decipher the content of these messages. In some scenarios, the ERMS may have the ability to automatically provide acknowledgments to incoming messages. For example, the ERMS may send email messages to the customers to acknowledge receipt of the original messages sent by these customers.

To further process incoming email messages, the ERMS typically must assign the messages to response agents or experts who can process the messages manually by reviewing their descriptions solving the identified problems. In addition, the ERMS may provide a graphical display of certain monitored statistics that provide a user, such as a supervisor, with an information summary of email messages as they are processed (either directly by the ERMS or manually by the agents or experts).

### SUMMARY

Various implementations are provided herein. One implementation provides a method for providing a graphical user interface (GUI) that allows a user to customize processing of incoming electronic mail (email) messages. This method is performed in a system that receives incoming email messages and manages events that may alter statuses of these messages. The method includes displaying in the GUI representations of predefined events that may occur during various stages of processing of incoming email messages, and receiving input from the user to map a predefined event to a predefined status indicator, such that the system assigns the predefined status indicator to an incoming email message when the predefined event that affects the incoming email message occurs.

Various implementations may provide certain advantages. For example, one implementation provides a customizing application that allows users and companies to choose the type of information that is to be monitored or reported by the ERMS at run time. One application allows a user to define the status indicators for emails in the ERMS and to set certain attributes that control the changeability of the status indicators, and also to view sequence and visibility information for the ERMS monitoring. Another application enables the user to define events and assign them to particular status indicators.

The details of one or more implementations are set forth in the accompanying drawings and the description below. Other features, objects, and advantages will be apparent from the description and drawings, and from the claims.

### DESCRIPTION OF DRAWINGS

FIG. 1A is a block diagram of a system that may be used to process electronic mail (email) messages sent from one or more user devices, according to one implementation.

FIG. 1B is a block diagram showing additional details of the email response management system (ERMS) in FIG. 1A, according to one implementation.

FIG. 1C is a block diagram showing further additional details of the ERMS in FIG. 1A, according to one implementation.

FIG. 2A is a diagram showing a relationship between a status indicator object and event objects for the system shown in FIG. 1A, according to one implementation.

FIG. 2B is a diagram showing a relationship between an email message object and email action objects that occur in the system shown in FIG. 1A, according to one implementation.

FIG. 3 is a screen diagram of a window in a graphical user interface (GUI) that contains various monitored statistics, according to one implementation.

FIG. 4 is a screen diagram of another window in the GUI that may be used for customizing the display status indicators that are shown in FIG. 3, according to one implementation.

FIG. 5 is a screen diagram of another window in the GUI that may be used for assigning events to status indicators, according to one implementation.

FIG. 6 is a block diagram of a computing device that may be included within the user devices, the agent devices, the supervisor device, or the ERMS shown in FIG. 1, according to one implementation.

### DETAILED DESCRIPTION

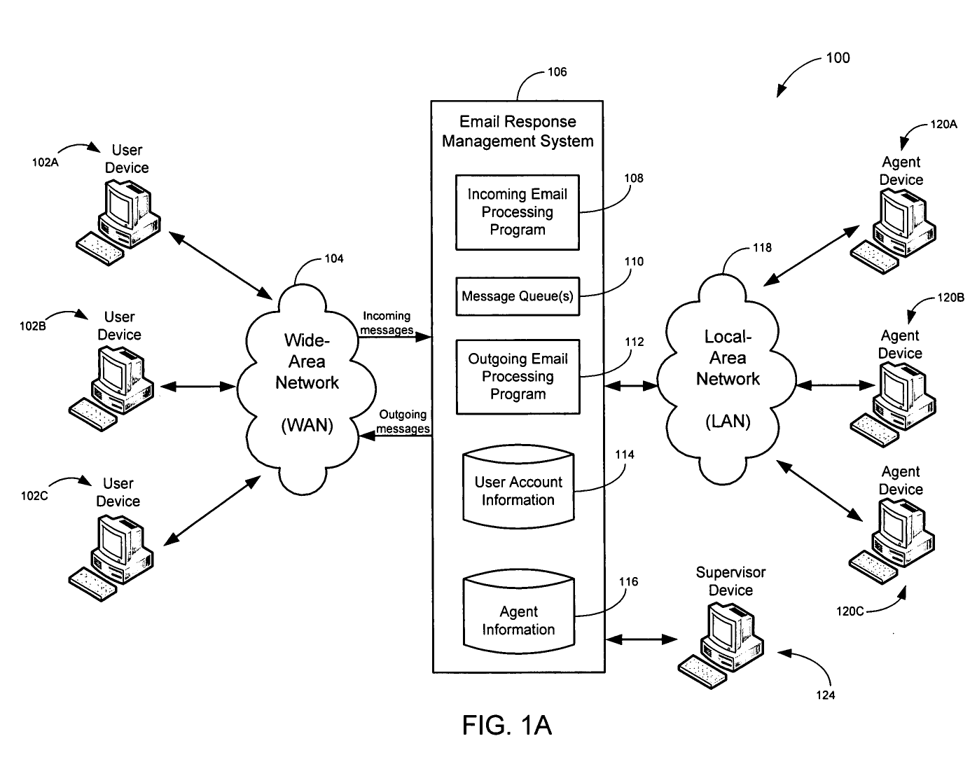

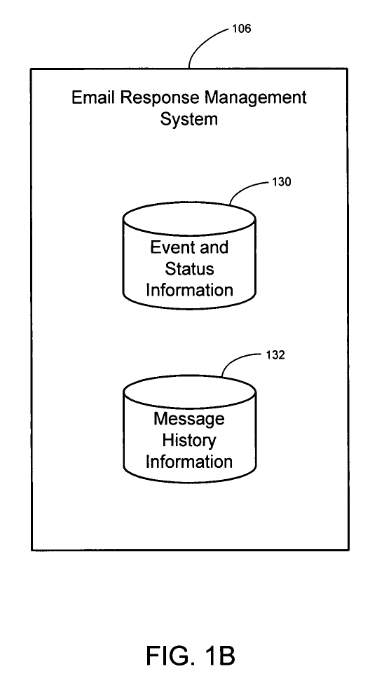

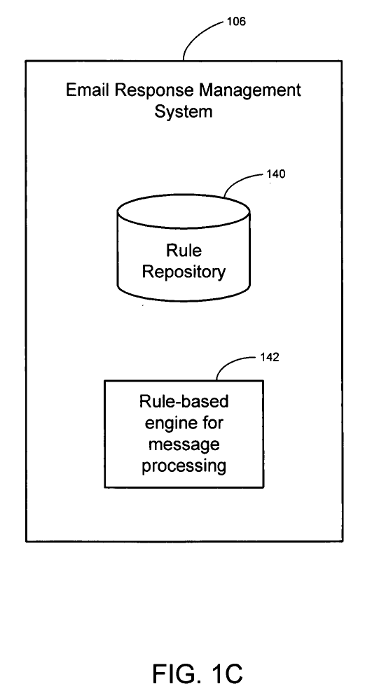

FIG. 1A is a block diagram of a system 100 that may be used to process electronic mail (email) messages sent from user devices 102A, 102B, and 102C, according to one implementation. The incoming email messages may be processed directly by an email response management system (ERMS) 106, and they also may be processed in a manual fashion by agents who use the devices 120A, 120B, and/or 120C. These agents are capable of handling the processing of various types of email messages based upon the problems identified in these messages. The user devices 102A, 102B, and 102C are each coupled to a wide-area network (WAN) 104, such as an Internet or wireless network. The ERMS 106 is also coupled to the WAN 104. Each the of user devices 102A, 102B, and 102C are capable of sending email messages to the ERMS 106 through the WAN 104, and the ERMS 106 is capable of sending email response messages to the user devices 102A, 102B, and 102C. The ERMS 106 is further capable of providing display information to a user, such as an administrator using the device 124, that shows the number of email messages that have been received from the user devices 102A, 102B, and 102C, as well as status information relating to these messages. The administrator may also use a graphical user interface (GUI) to customize the layout and organization of the information displayed on the device 124 based upon the events recognized and processed by the ERMS 106, as will be described in further detail below. This customization allows the administrator to view the displayed information in a manner that is well suited to the administrator's needs or preferences.

The ERMS 106 is also coupled to a local-area network (LAN) 118, such as an Ethernet network. Using the LAN 118, the ERMS 106 is able to communicate with the agent devices 120A, 120B, and 120C. The ERMS 106 is capable of assigning incoming email messages to an agent who uses one of the agent devices 120A, 120B, or 120C. Both the ERMS 106 and the agent devices 120A, 120B, and 120C are capable of performing various actions when processing incoming messages. In one scenario, a user of the user device 102A may encounter a problem with their home personal computer. In hopes of obtaining assistance, the user may use the user device 102A to send an email message to the ERMS 106. The user may describe the type of computer and the problem encountered within the contents of the email message. Upon analysis of the email message, the ERMS 106 may determine that an agent using the agent device 120A is an expert with the type of computer described within the message. In this case, the ERMS 106 may assign the email message to this agent and route the message to the agent device 120A for manual processing. If the agent is able to identify a solution to the problem described in the message, the agent may use the agent device 120A to send a response message back to the ERMS 106. The response message includes a description of the identified solution. The ERMS 106 is then capable of routing the response message back the user device 102A.

In one implementation, the ERMS 106 provides only a display of the email message to the agent using an agent device, such as the agent device 120A, and retains the email message for storage within the ERMS 106. The email message may be retained within the message queue component 110 or within another storage component after its contents have been provided for display on the agent device 120A, 120B, or 120C.

If the agent using the agent device 120A, 120B, or 120C reviews the content of an email message that has been routed to the device or whose content has been displayed on the device, the agent may provide a response message to the ERMS 106. The response message may include, for example, a description of an identified solution. The ERMS 106 is then capable of routing the response message back the user device 102A. If an incoming email message has been stored within the ERMS 106 after its contents have been provided to and displayed on an agent device 120A, 120B, or 120C, it can be removed from storage if a corresponding response message has been provided, according to one implementation. In one implementation, an agent may also choose to delete an incoming email message after having reviewed its content. For example, the agent may decide than an email message should be deleted after having determined that it is a “spam” message.

In one implementation, the agents using the devices 120A, 120B, and 120C may be grouped into organizational units. For example, the agents using the agent devices 120A and 120B may be grouped into a first organizational unit that handles problems with home computers. If the ERMS 106 analyzes an incoming email message and determines that the message describes a problem with a home computer system, the ERMS 106 may assign the message to an agent using the device 120A or 120B. In this example, the agent device 120C may be grouped into a second organization unit that handles problems with automobiles. If the ERMS 106 analyzes another incoming email message and determines that the message describes a problem with an automobile, the ERMS 106 may assign the message to the agent using the device 120C.

In one implementation, the ERMS 106 provides display information to the device 124 that represents a quantity of received email messages that have yet to be processed by a specific entity, such as an agent or an organization, within a predefined time period. These email messages are ones that have been received from the user devices 102A, 102B, and/or 102C. For example, the ERMS 106 may provide such display information when incoming email messages have not yet been assigned to or processed by an agent using the device 120A, 120B, or 120C within the past two hours. For instance, if the ERMS 106 has received thirty new email messages within the past two hours, the ERMS 106 may have assigned each of these messages to one or more agents. These one or more agents may have fully processed twenty of these messages, but may not have even reviewed or started manual processing of the remaining ten messages. If these remaining ten messages are still in queue, the ERMS 106 may provide display information indicating that these ten messages have been in queue for less than (or equal to) two hours. In conducting its analysis, the ERMS 106 determines a first value that is associated with a first quantity of received email messages that have yet to be processed by one or more agents within the past two hours. Upon such determination, the ERMS 106 causes to be displayed in a graphical user interface (GUI) on the device 124 a first representation of the first value in relation to the one or more agents and the two-hour time period. The ERMS 106 may also provide display information that represents a quantity of received email messages that have yet to be processed within multiple predefined time periods.

The ERMS 106 includes an incoming email processing program 108 that, when executed, processes incoming email messages received from the user devices 102A, 102B, and 102C. The program 108 includes instructions that cause the ERMS 108 to perform various actions, such as analyzing content of incoming messages and routing assigned messages to the agent devices 120A, 120B, and/or 120C. The program 108 also includes instructions that cause the ERMS 108 to store unassigned or unprocessed messages in a message queue component 110. Once messages are processed, their corresponding entries are removed from the message queue component 110.

The ERMS 106 also includes an outgoing email processing program 112 that, when executed, processes outgoing email messages that are sent back to the user devices 102A, 102B, and/or 102C. The program 112 includes instructions that cause the ERMS 108 to perform various actions, such as processing response messages provided by the agent devices 120A, 120B, and/or 120C and routing these outgoing messages to the user devices 102A, 102B, and/or 102C.

In one implementation, the ERMS 106 is capable of automatically processing incoming email messages and providing outgoing email response messages without communicating with the agent devices 120A, 120B, and/or 120C. In this implementation, the program 108 causes the ERMS 106 to analyze the content of incoming messages. The programs 108 and 112 use a rule-based engine to automatically create response messages that address issues or problems identified within the incoming messages without user intervention. The program 112 then causes the ERMS 106 to send these response messages to the user devices 102A, 102B, and/or 102C.

When processing incoming and/or outgoing email messages, the ERMS 106 may access and use user account information 114 and/or agent information 116. The user account information 114 includes information about the users of the devices 102A, 102B, and 102C. For example, if these users are customers, the user account information 114 may include name information, shipping address information, email address information, and the like. By using the user account information 114, the ERMS 106 is capable of associating incoming email messages with particular customers.

The agent information 116 includes information about the agents using the devices 120A, 120B, and 120C. For example, the agent information 116 may include name information, email address information, area of expertise information, and the like. When the ERMS 106 analyzes an incoming email message, the ERMS 106 may be able to use the agent information 116 to identify an agent who can address a problem described in the message and then route the message to that agent on the corresponding device 120A, 120B, or 120C. In one implementation, the agent information 116 also includes relationship information between organizational units and the agents that are members of these units.

FIG. 1B is a block diagram showing additional details of the ERMS 106 shown in FIG. 1A, according to one implementation. As shown in FIG. 1B, the ERMS 106 further includes event and status information 130 and message history information 132. The event and status information 130 includes information about the events that are recognized and can be managed by the ERMS 106 when various actions are performed by the ERMS 106 or by the agent devices 120A, 120B, and/or 120C. These various events can occur when the ERMS 106 processes incoming email messages from the user devices 102A, 102B, and/or 102C, or when the ERMS 106 communicates with the agent devices 120A, 120B, and/or 120C and processes outgoing email message. For example, the event and status information 130 may include information about events associated with actions such as the receipt of new incoming email messages, the creation of response messages, the transmission of response messages, the deletion of messages, and the like. The ERMS 106 and the agent devices 120A, 120B, and 120C are all capable of generating events during the processing of email messages when corresponding actions occur. If the agent devices 120A, 120B, or 120C generate events, they also provide notification of the generation of these events to the ERMS 106. The ERMS 106 then manages the handling of the generated events.

The event and status information 130 also includes status information associated with email messages as they are processed by the ERMS 106. These email messages may have various different statuses as they are processed. For example, an email message may have an associated status of “in queue” when it is placed within the message queue component 110, and may later have an associated status of “deleted” when it is removed from the message queue component 110 and deleted by the ERMS 106. Events and statuses are described in further detail below.

The event and status information 130 also includes information that maps events to statuses in general. For example, the ERMS 106 can use this mapping information to determine the next status of an email message when it processes a new event. The mapping information may specify that an email message is to have a status of “in queue” when the ERMS 106 accepts the message into the system upon receipt from one of the user devices 102A, 102B, or 102C.

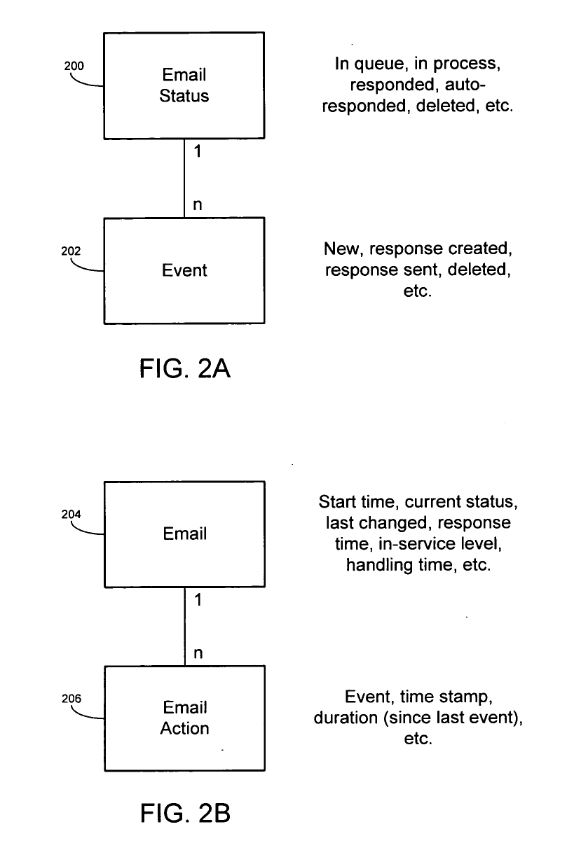

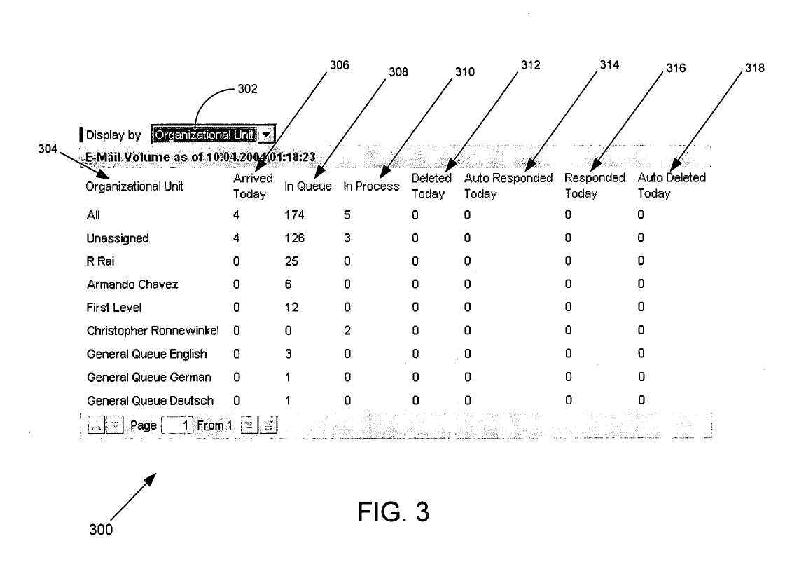

The ERMS 106 further includes email message history information 132. The history information 132 includes information about the histories of email messages as they processed by the ERMS 106. For example, the history information 132 may include information about the statuses of email messages being processed by the ERMS 106, the processing times of these messages, the various events that have occurred and that have affected these messages, and the like. FIG. 2B shows an example of the type of historical information that may be associated with a particular email message and that may be stored within the message history information 132. The ERMS 106 may use the history information 132 to provide a display of statistical information within a GUI on the device 124, such as is shown in FIG. 3 and will be described in more detail below.

FIG. 1C is a block diagram showing further additional details of the ERMS 106 in FIG. 1A, according to one implementation. In this implementation, the ERMS 106 includes a rule repository 140 and a rule-based engine 142 that is used for message processing. The rule-based engine 142 may be used by the incoming email processing program 108 and/or the outgoing email processing program 112 when processing messages. In one implementation, the ERMS 106 may include other engines that are similar to the engine 142. The engine 142 uses rules that are stored in the rule repository 140. The engine 142 may also access the user account information 114, the agent information 116, the event and status information 130, and/or the message history information 132 during processing.

During processing of incoming email messages, the program 108 uses the engine 142 in determining how to process these messages. In one implementation, one instance of the engine 142 is contained within the program 108. The rule repository 140 contains various rules that may be used by the engine 142. For example, the rule repository 140 may contain rules for use when analyzing the content of email messages. Certain rules may be targeted to the detection of advertising, or “spam”, messages. If the engine 142 uses these rules to detect a “spam” message, it provides an indication that this message should not be processed by the ERMS 106. The program 108 would also be capable of processing the indication provided by the engine 142 and automatically deleting the “spam” message (including any entry for the message that may have been initially stored in the message queue component 110, or information associated with the message that may have been stored in the message history information 132).

The engine 142 may also use rules contained within the repository 140 to provide information that may be used by the program 112 to prepare an automatic response message that is sent back to one of the devices 102A, 102B, or 102C. For example, the engine 142 may work in conjunction with the program 108 to analyze the content of a particular incoming email message. Upon use of the rules in the repository 140, the engine 142 may determine that an automatic response to the incoming message can be created. The engine 142 or the program 112 may create the response that is then sent to one of the client devices 102A, 102B, or 102C. The generated response may include both standard, predefined information as well as information that is tailored specifically to the content disclosed within the incoming message.

In one implementation, an administrator initially defines and stores a set of rules within the rule repository 140. One or more of these rules may be modifiable. For example, the ERMS 106 may have the ability to automatically modify the rules contained in the repository 140. In addition, a user of the device 124 may also manually modify the rules contained in the repository 140. If, for example, the user determines that the rules used for automatically deleting incoming “spam” messages are not defined properly, the user may manually modify these particular rules to improve the automatic message deletion process in subsequent iterations.

FIG. 2A is a diagram showing a relationship between a status indicator object 200 and event objects, such as an event object 202, for the system 100 shown in FIG. 1A, according to one implementation. As shown in FIG. 2A, one email status indicator object 200 can be assigned to “n” different event objects, such as the event object 202, where “n” is an integer greater than or equal to one. The status indicator object 200 is associated with a given email message to represent a current status of the message as it is being processed by the ERMS 106. For example, a message may have a status of “in queue” when it is stored within the message queue component 110. The message may have a status of “in process” when an assigned agent, such as an agent using the agent device 120A, 120B, or 120C, begins reviewing the message and preparing a response strategy. The message may have a status of “responded” (i.e., replied) or “auto-responded” when a response has been provided to the ERMS 106 automatically or by an agent and is ready for transmission to the user device 102A, 102B, or 102C. The message may have a status of “deleted” when it has been removed from the message queue component 110 and deleted from the system.

The event object 202 represents one of the events that is specifically assigned to the status indicator object 200. The event object 202 represents an event that is recognized an processed by the ERMS 106 and causes a change in status of a corresponding email message to that specified by the status indicator object 200. Events occur when corresponding actions are performed, such as deletions of email messages. As shown in FIG. 2A, the ERMS 106 may recognize various events, such as the arrival of a new email message, the creation of a response to this message, the transmission of the response, the deletion of a message, and the like. In one scenario, the event object 202 may represent an event specifying the arrival of a new incoming message from one of the user devices 102A, 102B, or 102C. The status indicator object 200 may be one specifying a status of “in queue”. In this case, the ERMS 106 will change a status of an incoming email message to “in queue”, as specified by the status indicator object 200, when the ERMS 106 processes an event represented by the event object 202 specifying that this new incoming email message has arrived from one of the user devices 102A, 102B, or 102C. The information regarding the status indicator object 200 and the event object 202, as well as the relationship between them, is contained within the event and status information 130.

In one implementation, the status indicator object 200 includes a boolean flag to indicate whether the status is final or non-final. When the status indicator object 200 includes a status that is final, the status indicator object 200 maintains this status regardless of the occurrence of subsequent events and their relationship to the status indicator object 200.

FIG. 2B is a diagram showing a relationship between an email message object 204 and email action objects, such as an email action object 206, that occur in the system 100 shown in FIG. 1A, according to one implementation. The email message object 204 contains an email message that has arrived from the user device 102A, 102B, or 102C and is processed by the ERMS 106. The email message object 204 is associated with “n” email action objects, such as the email action object 206, wherein “n” is an integer greater than or equal to one. The email message object 204 and the “n” email action objects are stored within the message history information 132 shown in FIG. 1B.

The email object 204 contains a copy of the corresponding email message, according to one implementation. In addition, the email object 204 contains additional meta information. For example, as shown in FIG. 2B, the email object 204 also contains a start time that indicates when the email message first entered the ERMS 106. The email object 204 contains a current status indicator. In one implementation, this indicator comprises the status object 200 shown in FIG. 2A. If the ERMS 106 has provided a response to one of the user devices 102A, 102B, or 102C, the email object 204 may contain a value for a response time that was needed to provide this response, or a value for a handling time that was needed by an agent using one of the devices 120A, 120B, or 120C when processing the email message. Additionally, the email object 204 may contain a Boolean flag that indicates whether the response and/or handling time fall within predefined customer service levels.

One or more email action objects, such as the action object 206 shown in FIG. 2B, can be associated with the email object 204. Each action object relates to a specific action that is taken to process the email message associated with the email object 204. For example, the ERMS 106 can take various actions when processing the email message when attempting to obtain or provide a response message that can be sent to one of the user devices 102A, 102B, or 102C. An individual action object 206 may contain event information. In one implementation, the event information comprises the event object 202 shown in FIG. 2A. The action object 206 may also contain a time stamp corresponding to a point in time when the corresponding action was taken. The action object 206 may further contain a duration value that specifies an amount of time that has elapsed since the last event affecting the email message was processed.

FIG. 3 is a screen diagram of a window 300 in a graphical user interface (GUI) that contains various monitored statistics, according to one implementation. In this implementation, the window 300 is displayed to a user on the supervisor device 124. This user may be an administrator or supervisor overseeing the operations of the ERMS 106 and the agents using the devices 120A, 120B, and 120C. By viewing the monitored statistics displayed on the device 124, the user may gain a better understanding of the incoming email volumes and the rates in which messages are being processed. The user may also be able to determine that certain agents are processing incoming messages more efficiently than others.

As shown in the FIG. 3, the window 300 provided within the GUI contains a selection menu 302 and graphical columns 304, 306, 308, 310, 312, 314, 316, and 318. A user may selection an option from the menu 302 to specify the entities that are to be displayed within the column 304. As shown in the example of FIG. 3, the user has selected the option to display the organizational unit entities that are registered within the ERMS 106 in the column 304. The user may select a different option from the menu 302 to display agent names or email addresses within the column 304 as well. In this scenario, the monitored statistics that are displayed within the remaining columns are based upon information relating to these specific agents.

The first two rows within the column 304 contain names for two predefined units. The first unit, named “All”, represents all of the defined organizational units known by the ERMS 106. The second unit, named “Unassigned”, represents a unit that is associated with the incoming email messages that have not yet been assigned to agents by the ERMS 106. The remaining rows within the column 304 contain names for other organizational units within the ERMS 106. These organizational units may comprise one or more entities or agents within the system. In certain cases, wherein the organizational unit includes only one agent, the name of the unit may correspond with the name of that agent (e.g., “R Rai” or “Armando Chavez”). In other cases, a name of an organizational unit may reflect a group of agents that are capable of handling certain types of problems described within incoming email messages (e.g., “First Level” for a first-level support unit). As shown in FIG. 3, organizational units may also have names that relate to one or more aspects of the incoming email messages received by the ERMS 106, and possibly the types of agents that could handle these messages. For example, one unit named “General Queue English” is associated with messages containing English text that can be handled by English-speaking agents. The incoming email processing program 108 (shown in FIG. 1A) is capable of analyzing incoming messages and determining whether they contain English text. The agent information 116 contains information regarding the fluency of the agents within the system 100, according to one implementation. Those agents speaking English would be capable of processing these messages. In one implementation, the English-speaking agents are also logically grouped into a special organizational unit. In general, agents may be a part of more than one organizational unit. The ERMS 106 may assign email messages containing English text to the organizational unit associated with English-speaking agents, or it may also directly assign one or more of these messages to individual, English-speaking agents. In addition, the ERMS 106 may include a content analysis program capable of recognizing text in various languages, such as English, to automatically process these messages.

The column 306 contains values for the number of incoming email messages that have arrived in the current day for each of the organizational units. As shown in the example of FIG. 3, a total of four messages have arrived and been received by the ERMS 106 today. These four messages have not yet been assigned. By viewing the information displayed in the column 306, a supervisor is capable of quickly determining the number of messages that have arrived in the current day and how many of these messages have been assigned to, or were directly addressed to, specific organizational units.

The column 308 contains values for the total, cumulative number of incoming email messages have been stored within the message queue component 110 and that are associated with the respective organizational units. In one implementation, email messages that have a current status indicator of “in queue” (as specified by a status object 200 associated with these messages) are represented by the values shown in the column 308. The messages that are contained within the message queue component 110 have not yet been processed by agents or organizational units within the system 100. In one implementation, the message queue component 110 contains one master queue to store all incoming messages. In one implementation, the message queue component 110 contains a set of different queues that are associated with various entities, such as individual agents or organizational units. In certain cases, the ERMS 106 has not yet assigned certain messages contained within the message queue component 110 to specific agents or units. By viewing the information displayed within the column 308, the supervisor is capable of determining the total number of messages that are in queue and also the number of these messages that have not yet been assigned. The supervisor may also be able to determine which agents or organizational units have a high number of messages that are still in queue. In such instances, the supervisor may wish to reassign messages to other agents or units having fewer messages in queue to balance workload.

The column 310 contains values for the number of incoming email messages that are currently being processed by the organizational units. Email messages that have a current status indicator of “in process” are represented by the values shown in the column 310. Once messages have been assigned and accepted for processing by organizational units, they are removed from the message queue component 110. The agents within these units process these messages using the devices 120A, 120B, and/or 120C.

The column 312 contains values for the number of email messages that have been deleted by the ERMS 106 in the current day for the various organizational units. In the example shown in FIG. 3, the values displayed within the column 312 correspond to the number of email messages that have been manually deleted by agents using one or more of the devices 120A, 120B, or 120C. In a common scenario, the ERMS 106 will assign incoming email messages to agents within the system 100. Once these agents accept and begin processing these messages, they may determine that one or more of the messages should be deleted. For example, if an agent analyzes the content of an email message and determines that the message is junk or advertising mail, the agent may manually delete the message. In this case, the status of the message may be changed to “deleted”. In one implementation, this status may be designated as a “final” status. If a message has a status designated as “final”, its status no longer changes. Thus, if a message has a status of “deleted”, and this status is designated as a “final” status by the ERMS 106, the status of this message will not be changed from “deleted”.

The column 318 contains values for the number of email messages that have been automatically deleted in the current day by the ERMS 106. The incoming email processing program 108 has the ability, in one implementation, to automatically analyze and delete incoming email messages before or after they are assigned to agents or organizational units. Typically, these messages are still placed within the message queue component 110. The messages are removed from the message queue component 110 when they are deleted by the ERMS 106. In some instances, the ERMS 106 is capable of deleting the messages before they are initially placed within the message queue component 110.

In one implementation, the incoming email processing program 108 performs content analysis of incoming email messages to determine if they are junk messages, for example, or if they contain advertising material (i.e., “spam”). In these situations, the program 108 can automatically delete these messages before they are processed by agents or organizational units within the system 100.

The column 316 contains values for the number of response messages that have been generated within the current day in response to incoming email messages that have been received by the ERMS 106. If an agent or organizational unit processes an incoming message and creates a response message (e.g., a response message describing a solution to a problem identified within the incoming message), this response is sent from one of the agent devices 120A, 120B, or 120C to the ERMS 106. The ERMS 106 is then capable of routing the response to the user device 102A, 102B, or 102C that had sent the incoming email message.

The column 314 contains values for the number of automated responses that have been generated by the ERMS 106 for incoming email messages that have been assigned to agents or organizational units. In one implementation, the ERMS 106 is also capable of generating automated responses to messages that have not yet been assigned but that have been stored within the message queue component 110. In one implementation, the ERMS 106 is capable of generating automated responses to messages before these messages are even stored in the message queue component 110.

When generating automated responses, the incoming email processing program 108 analyzes the content incoming email messages and uses a rule-based engine to identify issues or problems that are described within the text of these messages. The program 108 may also access the user account information 114 during this process to obtain additional information about the users who have sent these incoming messages. The program 108 then provides information about these messages, along with information about the content analysis output, to the outgoing email processing program 112.

The program 112 is then capable of generating automated responses to these messages and sending these responses to the user devices 102A, 102B, and/or 102C. The program 112 may also use a rule-based engine when creating these responses. In one implementation, the program 112 accesses and uses a set of predefined shell, or template, responses when generating the responses that are to be sent back to the user devices 102A, 102B, and/or 102C. When generating the responses, the program 112 may modify the information provided in the predefined shell responses. The program 112 may also attach relevant documents or knowledge entities to the generated responses that are sent back to the user devices 102A, 102B, and/or 102C. These documents or knowledge entities may be stored within a knowledge base located in or external to the ERMS 106.

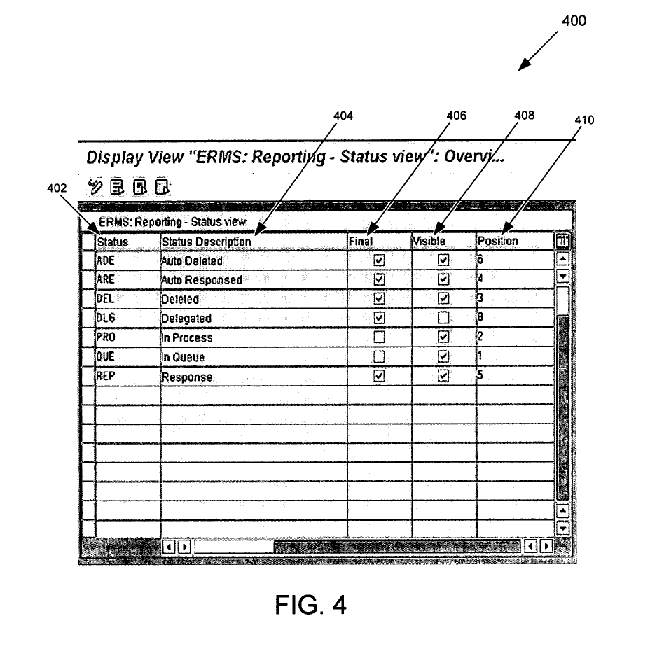

FIG. 4 is a screen diagram of another window 400 in the GUI that may be used for customizing the email status indicators that are shown in FIG. 3, according to one implementation. In this implementation, the window 400 may be presented within the GUI to a user of the device 124. By providing input into the window 400, the user may customize the status indicators that are displayed in the columns 308, 310, 312, 314, 316, and 318 shown in FIG. 3. This provides the user with the ability to specify which statuses are to be monitored and what type of information is to be displayed.

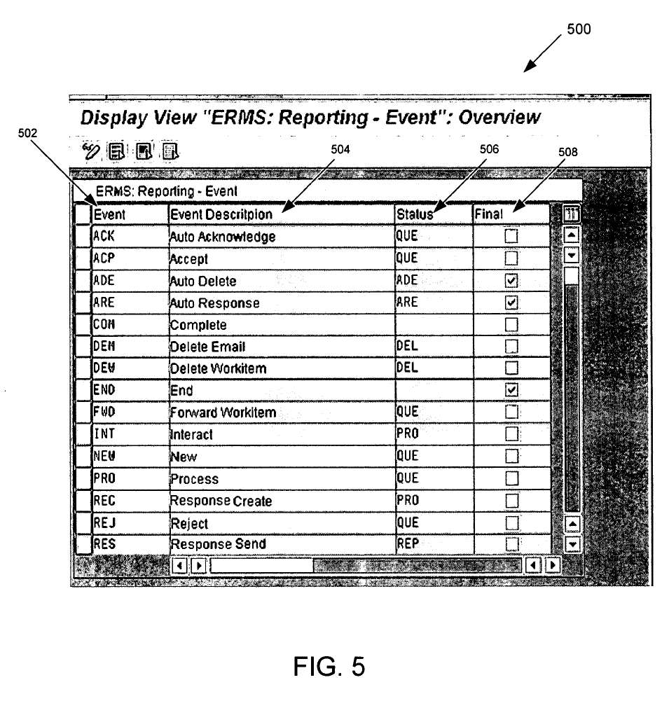

The window 400 includes columns 402, 404, 406, 408, and 410. The column 402 shows the abbreviated names of the various statuses that have been defined. As shown in FIG. 4, each status has a unique name abbreviation. In one implementation, the statuses are predefined. Information about these predefined statuses is stored within the repository 130 shown in FIG. 1B. The column 404 shows the status descriptions. In case the user is not familiar with or is the able to recognize the abbreviated names shown in the column 402, the user may read the corresponding descriptions that are displayed within the column 404. In one implementation, the user can change the names shown in the column 402 or the descriptions shown in the column 404 by editing the text directly within these respective columns. The various email statuses are described below in reference to the processing of messages within the system 100, according to one implementation. In general, events that occur and that are processed by the system 100 may cause the status associated with an individual email message to change. (Events are further described below in reference to FIG. 5) The descriptions below provide but just a few examples of status changes that are triggered by certain events. FIG. 5 shows additional examples of relationships between events and statuses.

When the ERMS 106 receives and begins processing an incoming email message from one of the user devices 102A, 102B, or 102C, it adds an entry for the message into the message queue component 110 and generates an event that causes the incoming message to acquire the status that is named “QUE” (assuming that the prior status of the message was not a final status, as will be outlined in more detail below).

If an email message is automatically deleted by the ERMS 106, it will acquire an associated status that is named “ADE” For example, the incoming email processing program 108 may analyze the content of the email message and determine that it includes advertising material, or “spam”. In this case, the program 108 may generate an event that causes the email message to be deleted.

If the ERMS 106 provides an automatic response to an incoming message, the message will have an associated status that is named “ARE”. In one implementation, the outgoing email processing program 112 generates an event and prepares a response message that is then sent to one of the devices 102A, 102B, or 102C. If the ERMS 106 is able to provide an automatic response to the message, it is not necessary for the ERMS 106 to assign the message to a user of one of the devices 120A, 120B, or 120C for handling, according to one implementation.

If the ERMS 106 is not able to automatically provide a response to or delete an incoming email message, it may assign the message to an agent for processing. The agent uses one of the agent devices 120A, 120B, or 120C. The incoming email processing program 108 generates an event to indicate that the message has been assigned.

Once the agent is ready to begin reviewing the message, the agent may trigger an event that is generated by one of the devices 120A, 120B, or 120C and propagated to the ERMS 106 to indicate that the agent has begun an active interaction. At this point, the message will have an associated status that is named “PRO”. Once the agent reviews the assigned message, the agent may decide to either continue handling the message or to delegate the handling of the message, according to one implementation. The agent may choose to delegate the handling of the message if, for example, the agent does not have time to handle the message, or if the agent feels that another agent would be better suited in handling the message. If the agent chooses to delegate the handling of the message, the agent device 120A, 120B, or 120C generates a corresponding event that is propagated to the ERMS 106. Once the event is processed by the ERMS 106, the message acquires the status that is named “DLG”, and the ERMS 106 re-assigns the message to a delegated agent.

If, on the other hand, the agent chooses to continue handling the message, the agent then determines whether to delete or respond to the message. For example, the agent may determine that the message includes only advertising, or “spam”, material. In this case, the agent may decide to delete the message rather than responding to it. In this case, the agent device 120A, 120B, or 120C used by the agent will generate a corresponding event that is propagated to the ERMS 106. Once the event is processed, the message acquires the status that is named “DEL”, and its corresponding entry is removed from the message queue component 110.

If the agent has determined that the message does not include “spam” material, the agent may prepare a response message that addresses the issues, problems, etc., that are identified within the content of the message. The agent device 120A, 120B, or 120C sends a completed response message to the ERMS 106. The agent device 120A, 120B, or 120C also generates a corresponding event (indicating that a response has been generated) that is provided to the ERMS 106. The ERMS 106 then forwards the response message to the same user device 102A, 102B, or 102C that had sent the incoming message. The ERMS 106 generates an event indicating that the response message has been sent, and the original incoming message acquires the status named “REP”.

Referring again to the window 400 shown in FIG. 4, the column 406 shows a set of selectable checkboxes for each of the statuses. By selecting one of the checkboxes in the column 406, the user is able to specify which of the corresponding statuses are “final” statuses. During operation of the system 100 shown in FIG. 1, an email message may be associated with various different statuses while it is being processed. As shown in FIG. 2A, various events, such as the one represented by the event object 202, can cause a status of an email message to change, such as to the status represented by the status object 200. If an email message, during its lifecycle within the run-time system 100, has an associated status that has been configured to be a “final” status, the email message will continue to have this associated status regardless of subsequent events that occur relating to the email message. That is, the associated status of the email message does not change if it is a “final” status. Any status may be configured to be a “final” status, according to one implementation. In the example shown in FIG. 4, the user has selected various checkboxes within the column 406. For instance, the user has selected the top-most checkbox in the column 406 to specify that the “ADE” status (Auto Deleted) is to be a final status. Therefore, if an email message has an associated status named “ADE” during run time (indicating that the message has been automatically been deleted by the ERMS 106), the status of the email message will remain unchanged regardless of any other events that may occur with respect to that message.

The column 408 displays another set of checkboxes to indicate whether statuses are visible within one of the columns of the window 300. If the user selects a given checkbox, the corresponding status is displayed within one of these columns. If a status is visible, the various monitored statistics for that status will be displayed within the window 300. The column 410 displays the column position of each status that may be visible in the widow 300. A position of “1” corresponds with the column 308, and a position of “6” corresponds with the column 318, according to the examples shown in FIG. 3 and FIG. 4. If a status is not visible, its position setting is ignored. The user may change the values of the positions shown in the column 410 to customize the layout of the information that is shown during run-time in the window 300.

FIG. 5 is a screen diagram of another window 500 in the GUI that may be used for assigning events to status indicators, according to one implementation. The window 500 may be displayed within the GUI to a user of the device 124. One or more events may be assigned to a given status. As shown in FIG. 2A, for example, an event represented by the event object 202 is assigned to the status represented by the status object 200. Information regarding the assignment of events to statuses is stored in the repository 130 shown in FIG. 1B, according to one implementation. If a given event occurs that affects a particular email message within the system 100, the email message will then have a status that is assigned to the given event (unless the message previously had a status that was “final”, in which case the status would remain unchanged).

The window 500 includes columns 502, 504, 506, and 508. The column 502 shows a list of abbreviated names for events that have been defined and stored within the repository 130. The user may change the names of one or more of the displayed names in the column 502. The column 504 shows a list of event descriptions that correspond to the names shown in the column 502. The user may also change one of more of these event descriptions by entering text within the column 504. If the user changes any information within the columns 502 or 504, these changes are stored within the repository 130. The various events are described in more detail below in reference to the processing of messages within the system 100, according to one implementation.

The event named “NEW” is generated by the ERMS 106 when it receives a new, incoming email message from one of the user devices 102A, 102B, or 102C. At this point, the ERMS 106 also stores the message in the message queue component 110, according to one implementation. As shown in FIG. 5, the event named “NEW” is mapped to the status named “QUE” (indicating that a message is in queue). As such, when the event named “NEW” is generated, the original incoming email message will acquire the associated status that is named “QUE”, assuming that the previous status of the message was not a “final” status.

The event named “ACK” is generated by the outgoing email processing program 112 when an automatic acknowledgement message has been generated and sent to one of the user devices 102A, 102B, or 102C. Often, when the ERMS 106 receives an incoming email message from one of these user devices, the ERMS 106 is capable of sending an acknowledgement message to indicate that the incoming message has been received and will be processed.

The event named “PRO” is generated by one of the agent devices 120A, 120B, or 120C when an individual agent selects, opens, and reviews an email message without beginning, or intending to begin, a formal interactive session. The corresponding agent device 120A, 120B, or 120C notifies the ERMS 106 of the event, so that the ERMS 106 may process the event. The agent may choose to open and review a message without beginning an interactive session if the agent only wishes, for example, to briefly view the message. If the agent wishes to actually process the message, the agent can then begin an interactive session, thereby triggering an event named “INT” (which is described in more detail below).

The event named “FWD” is generated by one of the agent devices 120A, 120B, or 120C (and then propagated to the ERMS 106) when an agent manually assigns an email message to another agent, or to an organizational unit in general. The agent may decide to assign a message if it contains subject matter that the agent feels could be addressed by another agent or organizational unit.

The event named “DEW” is generated by one of the agent devices 120A, 120B, or 120C when an agent manually deletes an email message without processing it during an interactive session. The agent may delete an email message in this fashion if, for example, the agent reviews the message (thereby causing the event named “PRO” to be generated) and is able to determine that the message contains advertising, or “spam”, material. In this case, the entry associated with the deleted message is also removed from the message queue component 110.

The event named “COM” is generated by one of the agent devices 120A, 120B, or 120C when an agent manually marks an email message as completed, without processing it during an interactive session. Typically, the event named “PRO” will be generated before this event. In one scenario, the agent may review the message and determine that it is strictly an informative message from a customer (such as a “thank you” note). In this case, the agent may mark the email message as completed, since no processing is necessary. The agent may also delete the message, in which case the event named “DEW” is generated.

The event named “ACP” is generated by one of the agent devices 120A, 120B, or 120C when an agent manually reserves an email message to be processed by the agent later. The ERMS 106 may have previously assigned this message to the agent for processing. When the agent reserves the email message in this fashion, the entry associated with this message contained in the message queue component 110 is no longer visible to other agents. As such, only one agent at a time is able to reserve an email message in this fashion, according to one implementation.

The event named “REJ” is generated by one of the agent devices 120A, 120B, or 120C when an agent who has previously reserved an email message for processing decides to reject the processing of the message. The agent may decide, for example, that he or she does not have sufficient time to process the message in a timely fashion, or that another agent may be more suited to handle the message. When the one agent device 120A, 120B, or 120C notifies the ERMS 106 of the generated event, the ERMS 106 will once again make visible the entry associated with the rejected message contained in the message queue component 110 (i.e., visible to other agents). Other agents may then reserve the message for processing.

The event named “INT” is generated by one of the agent devices 120A, 120B, or 120C when a given agent begins an interaction by processing an email message. For example, after the ERMS 106 has assigned the message to the agent, the agent may use a graphical user interface (GUI) provided on the one agent device 120A, 120B, or 120C to select an option indicating that the agent is ready to begin processing the message.

The event named “DEM” is generated by one of the devices 120A, 120B, or 120C when an agent decides to delete an incoming message. For example, the agent may decide to delete a “spam” message. If this occurs, the one device 120A, 120B, or 120C will send notification of the event to the ERMS 106. The ERMS 106 may then remove a corresponding entry for the message from the message queue component 110.

The event named “REC” is generated by one of the agent devices 120A, 120B, or 120C when an agent using the device has created a response message. The one agent device 120A, 120B, or 120C notifies the ERMS 106 of this event, and also sends the ERMS 106 the created response message. The event named “RES” is generated by the ERMS 106 when it sends the response message to one of the user devices 102A, 102B, or 102C.

The event named “ARE” is generated by the ERMS 106 when it automatically responds to an incoming message. The ERMS 106 may use a rule-based engine, such as the engine 142 shown in FIG. 1C, to analyze the content of the message and to generate an automatic response, as described above.

The event named “ADE” is generated by the ERMS 106 when it automatically deletes an incoming message. The ERMS 106 may, for example, delete an incoming message that contains advertising, or “sp am”, material. In this case, the ERMS 106 also removes a corresponding entry for the message from the message queue component 110.

In addition, the event named “END” is generated when the processing of an email message has been completed. In one implementation, this event is generated by one of the agent devices 120A, 120B, or 120C when an agent has completed the interactive session. Typically, the occurrence of this event will not change the status of the corresponding email message.

Referring again to the window 500 in FIG. 5, the column 506 shows the names of the statuses that are assigned to each of the events shown in the column 502. In one implementation, the user may directly enter text within the column 506 to specify the status names. If the user enters a name that is not recognized or stored within the information repository 130, an error message may be provided, and the user will need to enter another name. In another implementation, the GUI displays a pop-up menu of status names that are stored within the repository 130. The user is able to select names from the menu to specify the statuses that are to be mapped to events. More than one event may be mapped to the same status. The user may also choose not to map an event to a status. For example, as shown in FIG. 5, the events named “COM” and “END” are not mapped, or associated, with a status. Because these events are not mapped to any specific status, their occurrence does not affect, or change, the statuses of individual email messages when they are processed. The information regarding the assignments, or mappings, between statuses and events is stored in the repository 130.

The column 508 shows a set of selectable checkboxes. In one implementation, the user may specify that an event is a “final” event by selecting the corresponding checkbox. In FIG. 5, the user has specified that the events named “ADE”, “ARE”, and “END” are “final” events. If an event is a “final” event, it will trigger the calculation of various performance statistics, such as response time. For example, if the ERMS 106 is processing an email message, and the event named “END” occurs, the ERMS 106 may trigger a calculation to determine the amount of time it took to provide a response to this email message.

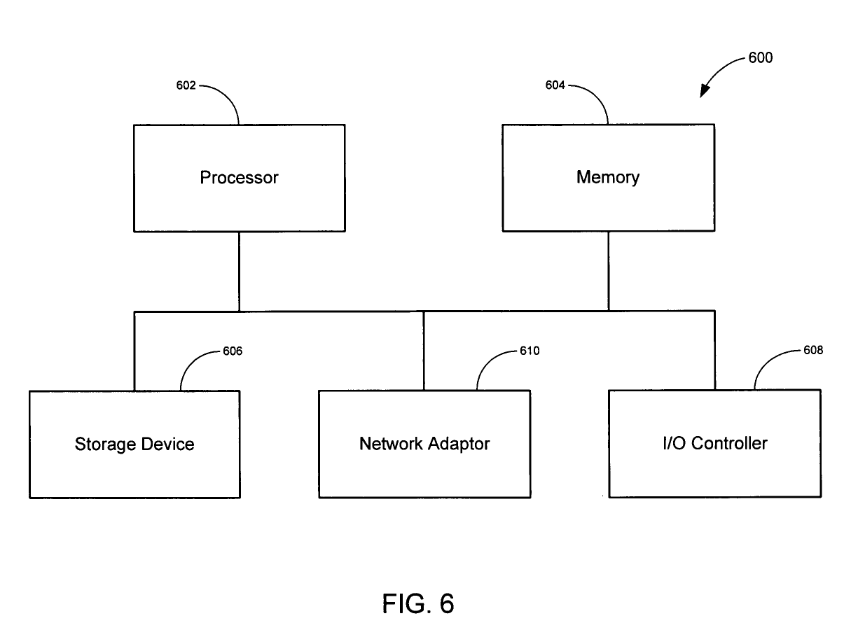

FIG. 6 is a block diagram of a computing device 600 that may be included within the user devices 102A, 102B, and/or 102C, the agent devices 120A, 120B, and/or 120C, the supervisor device 124, or the ERMS 106 shown in FIG. 1, according to one implementation. The computing device 600 includes a processor 602, a memory 604, a storage device 606, an input/output controller 608, and a network adaptor 610. Each of the components 602, 604, 606, 608, and 610 are interconnected using a system bus. The processor 602 is capable of processing instructions for execution within the computing device 600. In one implementation, the processor 602 is a single-threaded processor. In another implementation, the processor 602 is a multi-threaded processor. The processor 602 is capable of processing instructions stored in the memory 604 or on the storage device 606 to display graphical information for a GUI on an external input/output device that is coupled to the input/output controller 608.

The memory 604 stores information within the computing device 600. In one implementation, the memory 604 is a computer-readable medium. In one implementation, the memory 604 is a volatile memory unit. In another implementation, the memory 604 is a non-volatile memory unit.

The storage device 606 is capable of providing mass storage for the computing device 600. In one implementation, the storage device 606 is a computer-readable medium. In various different implementations, the storage device 606 may be a floppy disk device, a hard disk device, an optical disk device, or a tape device.

In one implementation, a computer program product is tangibly embodied in an information carrier. The computer program product contains instructions that, when executed, perform one or more methods, such as those described above. The information carrier is a computer- or machine-readable medium, such as the memory 604, the storage device 606, or a propagated signal.

The input/output controller 608 manages input/output operations for the computing device 600. In one implementation, the input/output controller 608 is coupled to an external input/output device, such as a keyboard, a pointing device, or a display unit that is capable of displaying various GUI's, such as the GUI's shown in the previous figures, to a user.

The computing device 600 further includes the network adaptor 610. The computing device 600 uses the network adaptor 610 to communicate with other network devices. If, for example, the user device 102A includes the computing device 600, the computing device 600 uses its network adaptor 610 to communicate with the ERMS 106 over the WAN 104.

A number of implementations have been described. Nevertheless, it will be understood that various modifications may be made without departing from the spirit and scope of these implementations. Accordingly, other implementations are within the scope of the following claims.

What is claimed is:

1. In a system that receives incoming electronic mail (email) messages and manages events that may alter statuses of these messages, a method for providing a graphical user interface (GUI) that allows a user to customize processing of incoming email messages, the method comprising:
displaying in the GUI representations of predefined events that may occur during various stages of processing of incoming email messages; and
receiving input from the user to map a predefined event to a predefined status indicator, such that the system assigns the predefined status indicator to an incoming email message when the predefined event that affects the incoming email message occurs.

2. The method of claim 1, further comprising receiving additional input from the user that specifies whether the predefined status indicator is associated with a final status once it is assigned to the incoming email message.

3. The method of claim 1, wherein receiving input from the user to assign the predefined event to the predefined status indicator includes receiving textual input from the user specifying a name of the predefined status indicator that is assigned to the predefined event.

4. The method of claim 1, wherein receiving input from the user to assign the predefined event to the predefined status indicator includes receiving a user selection of a name of the predefined status indicator that is assigned to the predefined event from a list of selectable names for status indicators that have been defined in the system.

5. The method of claim 1, wherein displaying representations of predefined events that may occur during various stages of processing of incoming email messages includes displaying representations of predefined events that may be triggered when corresponding actions are performed while processing incoming email messages.

6. The method of claim 5, wherein the predefined events may be triggered by the system when performing actions that do not involve human intervention.

7. The method of claim 6, wherein the predefined events may be triggered by the system when preparing automated responses to incoming email messages.

8. The method of claim 6, wherein the predefined events may be triggered by the system when deleting incoming email messages.

9. The method of claim 5, wherein the predefined events may be managed by the system upon notification of the predefined events from external devices that perform actions to process incoming email messages, and wherein human agents use the external devices.

10. The method of claim 1, further comprising receiving additional input from the user to assign a second predefined event to the predefined status indicator, such that the system assigns the predefined status indicator to an incoming email message when the second predefined event affecting the incoming email message occurs.

11. The method of claim 1, further comprising receiving additional input from the user specifying if the predefined status indicator and associated status information is to be visible within a separate GUI that displays status information for incoming email messages as they are processed by the system.

12. The method of claim 1, further comprising receiving additional input from the user specifying an event description for the predefined event.

13. The method of claim 12, further comprising receiving additional input from the user specifying a status description for the predefined status indicator.

14. A computer program product tangibly embodied in an information carrier, the computer program product including instructions that, when executed, perform a method for providing a graphical user interface (GUI) that allows a user to customize a display of electronic mail (email) message processing information in a system that receives incoming email messages and manages events that may alter statuses of these messages, the method comprising:
displaying representations of predefined events that may occur during various stages of processing of incoming email messages; and
receiving input from the user to assign a predefined event to a predefined status indicator, such that the system assigns the predefined status indicator to an incoming email message when the predefined event affecting the incoming email message occurs.

15. The computer program product of claim 14, wherein the method further comprises receiving additional input from the user that specifies whether the predefined status indicator is associated with a final status once it is assigned to the incoming email message.

16. The computer program product of claim 14, wherein receiving input from the user to assign the predefined event to the predefined status indicator includes receiving textual input from the user specifying a name of the predefined status indicator that is assigned to the predefined event.

17. The computer program product of claim 14, wherein receiving input from the user to assign the predefined event to the predefined status indicator includes receiving a user selection of a name of the predefined status indicator that is assigned to the predefined event from a list of selectable names for status indicators that have been defined in the system.

18. The computer program product of claim 14, wherein displaying representations of predefined events that may occur during various stages of processing of incoming email messages includes displaying representations of predefined events that may be triggered when corresponding actions are performed while processing incoming email messages.

19. The computer program product of claim 18, wherein the predefined events may be triggered by the system when performing actions that do not involve human intervention.

20. The computer program product of claim 19, wherein the predefined events may be triggered by the system when preparing automated responses to incoming email messages.

21. The computer program product of claim 19, wherein the predefined events may be triggered by the system when deleting incoming email messages.

22. The computer program product of claim 18; wherein the predefined events may be managed by the system upon notification of the predefined events from external devices that perform actions to process incoming email messages, and wherein human agents use the external devices.

23. The computer program product of claim 14, wherein the method further comprises receiving additional input from the user to assign a second predefined event to the predefined status indicator, such that the system assigns the predefined status indicator to an incoming email message when the second predefined event affecting the incoming email message occurs.

24. The computer program product of claim 14, wherein the method further comprises receiving additional input from the user specifying if the predefined status indicator and associated status information is to be visible within a separate GUI that displays status information for incoming email messages as they are processed by the system.

25. The computer program product of claim 14, wherein the method further comprises receiving additional input from the user specifying an event description for the predefined event.

26. The computer program product of claim 25, wherein the method further comprises receiving additional input from the user specifying a status description for the predefined status indicator.

27. A computer program product tangibly embodied in an information carrier, the computer program product including instructions that, when executed, provide a graphical user interface (GUI) that allows a user to customize a display of electronic mail (email) message processing information within a system that receives incoming email messages and manages events that may alter statuses of these messages, wherein the GUI comprises:
a first display area that displays representations of predefined events that may occur during various stages of processing of incoming email messages; and
an input area that receives input from the user to assign a predefined event to a predefined status indicator, such that the system assigns the predefined status indicator to an incoming email message when the predefined event affecting the incoming email message occurs.
